(19) United States
(12) Patent Application Publication
(10) Pub. No.: US 2014/0127504 A1
(43) Pub. Date: May 8, 2014

(54) URETHANE-BASED PRESSURE-SENSITIVE ADHESIVE AND SURFACE PROTECTIVE FILM USING THE PRESSURE-SENSITIVE ADHESIVE

(71) Applicant: NITTO DENKO CORPORATION, Osaka (JP)

(72) Inventors: Shogo SASAKI, Ibaraki-shi, Osaka (JP); Toru ISEKI, Ibaraki-shi, Osaka (JP); Shou UCHIDA, Ibaraki-shi, Osaka (JP); Masahiko ANDO, Ibaraki-shi, Osaka (JP)

(73) Assignee: NITTO DENKO CORPORATION, Osaka (JP)

(21) Appl. No.: 14/065,536

(22) Filed: Oct. 29, 2013

(30) Foreign Application Priority Data
Nov. 6, 2012 (JP) 2012-244085
Jan. 29, 2013 (JP) 2013-014313

(51) Int. Cl. C09J 11/06; C09J 7/02

(52) U.S. Cl. CPC C09J 11/06; C09J 7/021
USPC 428/355 N; 428/423.1; 524/291; 524/349; 524/91; 524/331; 524/110

(57) ABSTRACT

Provided is a urethane-based pressure-sensitive adhesive that is extremely excellent in adhesive residue-preventing property. Also provided is a surface protective film using such urethane-based pressure-sensitive adhesive in its pressure-sensitive adhesive layer, the surface protective film being extremely excellent in adhesive residue-preventing property. Also provided is an optical member or electronic member to which such surface protective film is attached. The urethane-based pressure-sensitive adhesive is a urethane-based pressure-sensitive adhesive including a polyurethane-based resin, in which: the polyurethane-based resin includes a polyurethane-based resin obtained by curing a composition containing a polyol (A) and a polyfunctional isocyanate compound (B); and the polyurethane-based resin contains a deterioration-preventing agent.

This application claims priority under 35 U.S.C. Section 119 to Japanese Patent Applications No. 2012-244085 filed on Nov. 6, 2012 and No. 2013-014313 filed Jan. 29, 2013, which are herein incorporated by reference.

### BACKGROUND OF THE INVENTION

1. Field of the Invention

The present invention relates to a urethane-based pressure-sensitive adhesive. A conventional urethane-based pressure-sensitive adhesive is generally known to be liable to cause an adhesive residue. However, the urethane-based pressure-sensitive adhesive of the present invention is extremely excellent in adhesive residue-preventing property. The present invention also relates to a surface protective film that uses such urethane-based pressure-sensitive adhesive. The surface protective film of the present invention includes a base material layer and a pressure-sensitive adhesive layer, and is preferably used in, for example, an application in which the film is attached to a surface of an optical member or an electronic member to protect the surface.

2. Description of the Related Art

Optical members and electronic members such as an LCD, an organic EL display, a touch panel using such display, a lens portion of a camera, and an electronic device may each have a surface protective film attached generally onto an exposed surface side thereof in order to prevent a flaw from occurring on a surface thereof upon processing, assembly, inspection, transportation, or the like. Such surface protective film is peeled from the optical member or the electronic member when the need for surface protection is eliminated.

In more and more cases, the same surface protective film is continuously used as such surface protective film, from a manufacturing step of the optical member or the electronic member, through an assembly step, an inspection step, a transportation step, and the like, until final shipping. In many of such cases, such surface protective film is attached, peeled off, and re-attached by manual work in each step.

When the surface protective film is attached by manual work, air bubbles may be trapped between an adherend and the surface protective film. Accordingly, there have been reported some technologies for improving wettability of a surface protective film so that air bubbles may not be trapped upon the attachment. For example, there is known a surface protective film that uses a silicone resin, which has a high wetting rate, in a pressure-sensitive adhesive layer. However, when the silicone resin is used in the pressure-sensitive adhesive layer, its pressure-sensitive adhesive component is liable to contaminate the adherend, resulting in a problem when the surface protective film is used for protecting a surface of a member for which particularly low contamination is required, such as the optical member or the electronic member.

As a surface protective film that causes less contamination derived from its pressure-sensitive adhesive component, there is known a surface protective film that uses an acrylic resin in a pressure-sensitive adhesive layer. However, the surface protective film that uses the acrylic resin in the pressure-sensitive adhesive layer is poor in wettability, and hence, when the surface protective film is attached by manual work, air bubbles may be trapped between the adherend and the surface protective film. In addition, when the acrylic resin is used in the pressure-sensitive adhesive layer, there is a problem in that an adhesive residue is liable to occur upon peeling, resulting in a problem when the surface protective film is used for protecting a surface of a member for which incorporation of foreign matter is particularly undesirable, such as the optical member or the electronic member.

As a surface protective film that is able to achieve both of excellent wettability, and low contamination property and adhesive residue reduction, there has recently been reported a surface protective film that uses a urethane-based pressure-sensitive adhesive in a pressure-sensitive adhesive layer (see, for example, Japanese Patent Application Laid-open No. 2006-182795).

However, the conventional urethane-based pressure-sensitive adhesive is generally known to be liable to cause an adhesive residue. For example, when the pressure-sensitive adhesive is stored in a warmed state after having been attached to an adherend, the following problem arises. The adhesive residue is liable to occur on the adherend.

In particular, a surface protective film to be used in the surface protection of an optical member or an electronic member is required to have extremely high adhesive residue-preventing property because an adhesive residue on an adherend largely affects product quality.

### SUMMARY OF THE INVENTION

An object of the present invention is to provide a urethane-based pressure-sensitive adhesive that is extremely excellent in adhesive residue-preventing property. Another object of the present invention is to provide a surface protective film using such urethane-based pressure-sensitive adhesive in its pressure-sensitive adhesive layer, the surface protective film being extremely excellent in adhesive residue-preventing property. Another object of the present invention is to provide an optical member or electronic member to which such surface protective film is attached.

A urethane-based pressure-sensitive adhesive of the present invention is a urethane-based pressure-sensitive adhesive including a polyurethane-based resin, in which:

the polyurethane-based resin includes a polyurethane-based resin obtained by curing a composition containing a polyol (A) and a polyfunctional isocyanate compound (B); and

the polyurethane-based resin contains a deterioration-preventing agent.

In a preferred embodiment, a content of the deterioration-preventing agent with respect to the polyol (A) is 0.01 wt % to 20 wt %.

In a preferred embodiment, the polyol (A) contains a polyol having a number-average molecular weight Mn of 400 to 20,000.

In a preferred embodiment, a content of the polyfunctional isocyanate compound (B) with respect to the polyol (A) is 5 wt % to 60 wt %.

In a preferred embodiment, the deterioration-preventing agent contains a deterioration-preventing agent having a hindered phenol structure.

A surface protective film of the present invention is a surface protective film including:

a base material layer; and

a pressure-sensitive adhesive layer,

in which the pressure-sensitive adhesive layer contains the urethane-based pressure-sensitive adhesive of the present invention.

An optical member of the present invention has the surface protective film of the present invention attached thereto.

An electronic member of the present invention has the surface protective film of the present invention attached thereto.

### BRIEF DESCRIPTION OF THE DRAWINGS

FIG. 1 is a schematic sectional view of a surface protective film according to a preferred embodiment of the present invention.

### DETAILED DESCRIPTION OF THE PREFERRED EMBODIMENTS

<<A. Urethane-Based Pressure-Sensitive Adhesive>>

A urethane-based pressure-sensitive adhesive of the present invention contains a polyurethane-based resin. The content of the polyurethane-based resin in the urethane-based pressure-sensitive adhesive of the present invention is preferably 50 wt % to 100 wt %, more preferably 70 wt % to 100 wt %, still more preferably 90 wt % to 100 wt %, particularly preferably 95 wt % to 100 wt %, most preferably 98 wt % to 100 wt %. Adjusting the content of the polyurethane-based resin in the urethane-based pressure-sensitive adhesive of the present invention within the range can provide a urethane-based pressure-sensitive adhesive excellent in, for example, reworkability, initial wettability, and transparency.

The polyurethane-based resin is a polyurethane-based resin obtained by curing a composition containing a polyol (A) and a polyfunctional isocyanate compound (B).

Any appropriate polyol can be adopted as the polyol (A) as long as the polyol has two or more OH groups. Examples of such polyol (A) include a polyol having two OH groups (diol), a polyol having three OH groups (triol), a polyol having four OH groups (tetraol), a polyol having five OH groups (pentaol), and a polyol having six OH groups (hexaol). The number of kinds of the polyols (A) may be only one, or may be two or more.

The polyol (A) preferably contains a polyol having a number-average molecular weight Mn of 400 to 20,000. The content of the polyol having a number-average molecular weight Mn of 400 to 20,000 in the polyol (A) is preferably 50 wt % to 100 wt %, more preferably 70 wt % to 100 wt %, still more preferably 90 wt % to 100 wt %, particularly preferably 95 wt % to 100 wt %, most preferably substantially 100 wt %. Adjusting the content of the polyol having a number-average molecular weight Mn of 400 to 20,000 in the polyol (A) within the range can provide a urethane-based pressure-sensitive adhesive excellent in, for example, reworkability, initial wettability, and transparency.

When the number-average molecular weight of the polyol (A) after heating under the conditions of a temperature of 130° C. and a time period of 1 hour is represented by Mn (after heating), and the number-average molecular weight thereof before the heating is represented by Mn (before heating), a number-average molecular weight reduction ratio calculated from an equation “number-average molecular weight reduction ratio (%)=(1−Mn (after heating)/Mn (before heating))×100” is preferably 10% or less, more preferably 9% or less, still more preferably 8% or less, particularly preferably 7% or less, most preferably 6% or less. A preferred lower limit for the number-average molecular weight reduction ratio is 0%. When the number-average molecular weight reduction ratio falls within the range, an effect of the present invention can be additionally expressed. It should be noted that details about a method of measuring the number-average molecular weight reduction ratio are described later.

Examples of the polyol (A) include a polyester polyol, a polyether polyol, a polycaprolactone polyol, a polycarbonate polyol, and a castor oil-based polyol.

The polyester polyol can be obtained by, for example, an esterification reaction between a polyol component and an acid component.

Examples of the polyol component include ethylene glycol, diethylene glycol, 1,3-butanediol, 1,4-butanediol, neopentyl glycol, 3-methyl-1,5-pentanediol, 2-butyl-2-ethyl-1,3-propanediol, 2,4-diethyl-1,5-pentanediol, 1,2-hexanediol, 1,6-hexanediol, 1,8-octanediol, 1,9-nonanediol, 2-methyl-1,8-octanediol, 1,8-decanediol, octadecanediol, glycerin, trimethylolpropane, pentaerythritol, hexanetriol, and polypropylene glycol.

Examples of the acid component include succinic acid, methylsuccinic acid, adipic acid, pimelic acid, azelaic acid, sebacic acid, 1,12-dodecanedioic acid, 1,14-tetradecanedioic acid, dimer acid, 2-methyl-1,4-cyclohexanedicarboxylic acid, 2-ethyl-1,4-cyclohexanedicarboxylic acid, terephthalic acid, isophthalic acid, phthalic acid, 1,4-naphthalenedicarboxylic acid, 4,4′-biphenyldicarboxylic acid, and acid anhydrides thereof.

Examples of the polyether polyol include a polyether polyol obtained by subjecting an alkylene oxide such as ethylene oxide, propylene oxide, or butylene oxide to addition polymerization through the use of an initiator such as water, a low-molecular-weight polyol (such as propylene glycol, ethylene glycol, glycerin, trimethylolpropane, or pentaerythritol), a bisphenol (such as bisphenol A), or dihydroxybenzene (such as catechol, resorcin, or hydroquinone). Specific examples thereof include polyethylene glycol, polypropylene glycol, and polytetramethylene glycol.

An example of the polycaprolactone polyol is a caprolactone-type polyester diol obtained by subjecting a cyclic ester monomer such as ε-caprolactone or σ-valerolactone to ring-opening polymerization.

Examples of the polycarbonate polyol include: a polycarbonate polyol obtained by subjecting the polyol component and phosgene to a polycondensation reaction; a polycarbonate polyol obtained by subjecting the polyol component and a carbonic acid diester such as dimethyl carbonate, diethyl carbonate, dipropyl carbonate, diisopropyl carbonate, dibutyl carbonate, ethylbutyl carbonate, ethylene carbonate, propylene carbonate, diphenyl carbonate, or dibenzyl carbonate to transesterification and condensation; a copolymerized polycarbonate polyol obtained by using two or more kinds of the polyol components in combination; a polycarbonate polyol obtained by subjecting each of the various polycarbonate polyols and a carboxyl group-containing compound to an esterification reaction; a polycarbonate polyol obtained by subjecting each of the various polycarbonate polyols and a hydroxyl group-containing compound to an etherification reaction; a polycarbonate polyol obtained by subjecting each of the various polycarbonate polyols and an ester compound to a transesterification reaction; a polycarbonate polyol obtained by subjecting each of the various polycarbonate polyols and a hydroxyl group-containing compound to a transesterification reaction; a polyester-type polycarbonate polyol obtained by subjecting each of the various polycarbonate polyols and a dicarboxylic acid compound to a polycondensation reaction; and a copolymerized polyether-type polycarbonate polyol obtained by subjecting each of the various polycarbonate polyols and an alkylene oxide to copolymerization.

An example of the castor oil-based polyol is a castor oil-based polyol obtained by allowing a castor oil fatty acid and the polyol component to react with each other. A specific example thereof is a castor oil-based polyol obtained by allowing a castor oil fatty acid and polypropylene glycol to react with each other.

The number of kinds of the polyfunctional isocyanate compounds (B) may be only one, or may be two or more.

Any appropriate polyfunctional isocyanate compound that may be used in a urethane-forming reaction may be adopted as the polyfunctional isocyanate compound (B). Examples of such polyfunctional isocyanate compound (B) include a polyfunctional aliphatic isocyanate compound, a polyfunctional alicyclic isocyanate compound, and a polyfunctional aromatic isocyanate compound.

Examples of the polyfunctional aliphatic isocyanate compound include trimethylene diisocyanate, tetramethylene diisocyanate, hexamethylene diisocyanate, pentamethylene diisocyanate, 1,2-propylene diisocyanate, 1,3-butylene diisocyanate, dodecamethylene diisocyanate, and 2,4,4-trimethylhexamethylene diisocyanate.

Examples of the polyfunctional alicyclic isocyanate compound include 1,3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate, and hydrogenated tetramethylxylylene diisocyanate.

Examples of the polyfunctional aromatic diisocyanate compound include phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, and xylylene diisocyanate.

Other examples of the polyfunctional isocyanate compound (B) include trimethylolpropane adducts of the various polyfunctional isocyanate compounds as described above, biurets thereof obtained through their reactions with water, and trimers thereof each having an isocyanurate ring. In addition, they may be used in combination.

The polyurethane-based resin is obtained by curing a composition containing the polyol (A) and the polyfunctional isocyanate compound (B). Such composition may contain any appropriate other component in addition to the polyol (A) and the polyfunctional isocyanate compound (B) as long as the effects of the present invention are not impaired. Examples of such other component include a catalyst, a resin component other than the polyurethane-based resin, a tackifier, an inorganic filler, an organic filler, metal powder, a pigment, a foil-shaped material, a softener, a plasticizer, an age resistor, a conductive agent, an antioxidant, a UV absorbing agent, alight stabilizer, a surface lubricating agent, a leveling agent, a corrosion inhibitor, a heat stabilizer, a polymerization inhibitor, a lubricant, and a solvent.

The polyurethane-based resin in the present invention contains a deterioration-preventing agent such as an antioxidant, a UV absorbing agent, or a light stabilizer. When the polyurethane-based resin contains the deterioration-preventing agent, the pressure-sensitive adhesive can be excellent in adhesive residue-preventing property. Specifically, even when the pressure-sensitive adhesive is stored in a warmed state after having been attached to an adherend, an adhesive residue hardly occurs on the adherend. The number of kinds of the deterioration-preventing agents may be only one, or may be two or more.

The content of the deterioration-preventing agent is preferably 0.01 wt % to 20 wt %, more preferably 0.05 wt % to 15 wt %, still more preferably 0.1 wt % to 10 wt % with respect to the polyol (A). Adjusting the content of the deterioration-preventing agent within the range can make the pressure-sensitive adhesive additionally excellent in adhesive residue-preventing property. Specifically, even when the pressure-sensitive adhesive is stored in a warmed state after having been attached to an adherend, an adhesive residue occurs on the adherend in an additionally hard manner. When the content of the deterioration-preventing agent is excessively small, it may become impossible to express the adhesive residue-preventing property sufficiently. When the content of the deterioration-preventing agent is excessively large, the following problems may arise: a disadvantage in terms of cost appears, pressure-sensitive adhesive characteristics cannot be maintained, or the adherend is contaminated.

Examples of the antioxidant include a radical chain inhibitor and a peroxide decomposer.

Examples of the radical chain inhibitor include a phenol-based antioxidant and an amine-based antioxidant.

Examples of the peroxide decomposer include a sulfur-based antioxidant and a phosphorus-based antioxidant.

Examples of the phenol-based antioxidant include a monophenol-based antioxidant, a bisphenol-based antioxidant, and a high-molecular-weight phenol-based antioxidant.

Examples of the monophenol-based antioxidant include 2,6-di-t-butyl-p-cresol, butylated hydroxyanisole, 2,6-di-t-butyl-4-ethylphenol, and stearin-β-(3,5-di-t-butyl-4-hydroxyphenyl)propionate.

Examples of the bisphenol-based antioxidant include
2,2′-methylenebis(4-methyl-6-t-butylphenol),
2,2′-methylenebis(4-ethyl-6-t-butylphenol),
4,4′-thiobis(3-methyl-6-t-butylphenol),
4,4′-butylidenebis(3-methyl-6-t-butylphenol), and
3,9-bis[1,1-dimethyl-2-[β-(3-t-butyl-4-hydroxy-5-methylphenyl)propionyloxy]ethyl]2,4,8,10-tetraoxaspiro[5.5]undecane.

Examples of the high-molecular-weight phenol-based antioxidant include
1,1,3-tris(2-methyl-4-hydroxy-5-t-butylphenyl)butane,
1,3,5-trimethyl-2,4,6-tris(3,5-di-t-butyl-4-hydroxybenzyl)benzene,
tetrakis-[methylene-3-(3′,5′-di-t-butyl-4′-hydroxyphenyl)propionate]methane,
bis[3,3′-bis-(4′-hydroxy-3′-t-butylphenyl)butyric acid] glycol ester,
1,3,5-tris(3′,5′-di-t-butyl-4′-hydroxybenzyl)-S-triazine-2,4,6-(1H,3H,5H)trione, and tocophenol.

Examples of the sulfur-based antioxidant include dilauryl 3,3′-thiodipropionate, dimyristyl 3,3′-thiodipropionate, and distearyl 3,3′-thiodipropionate.

Examples of the phosphorus-based antioxidant include triphenyl phosphite, diphenyl isodecyl phosphite, and phenyl diisodecyl phosphite.

Examples of the UV absorbing agent include a benzophenone-based UV absorbing agent, a benzotriazole-based UV absorbing agent, a salicylic acid-based UV absorbing agent, an oxalic anilide-based UV absorbing agent, a cyanoacrylate-based UV absorbing agent, and a triazine-based UV absorbing agent.

Examples of the benzophenone-based UV absorbing agent include 2,4-dihydroxybenzophenone, 2-hydroxy-4-methoxybenzophenone, 2-hydroxy-4-octoxybenzophenone, 2-hydroxy-4-dodecyloxybenzophenone, 2,2′-dihydroxy-4-dimethoxybenzophenone, 2,2′-dihydroxy-4,4′-dimethoxybenzophenone, 2-hydroxy-4-methoxy-5-sulfobenzophenone, and bis(2-methoxy-4-hydroxy-5-benzoylphenyl)methane.

Examples of the benzotriazole-based UV absorbing agent include
2-(2′-hydroxy-5′-methylphenyl)benzotriazole,
2-(2′-hydroxy-5′-tert-butylphenyl)benzotriazole,
2-(2′-hydroxy-3′,5′-di-tert-butylphenyl)benzotriazole,
2-(2′-hydroxy-3′-tert-butyl-5′-methylphenyl)-5-chlorobenzotriazole,
2-(2′-hydroxy-3′,5′-di-tert-butylphenyl)-5-chlorobenzotriazole,
2-(2′-hydroxy-3′,5′-di-tert-amylphenyl)benzotriazole,
2-(2′-hydroxy-4′-octoxyphenyl)benzotriazole,
2-[2′-hydroxy-3′-(3″,4″,5″,6″-tetrahydrophthalimidomethyl)-5′-methylphenyl]benzotriazole,
2,2′-methylenebis[4-(1,1,3,3-tetramethylbutyl)-6-(2H-benzotriazole-2-yl)phenol], and
2-(2′-hydroxy-5′-methacryloxyphenyl)-2H-benzotriazole.

Examples of the salicylic acid-based UV absorbing agent include phenyl salicylate, p-tert-butylphenyl salicylate, and p-octylphenyl salicylate.

Examples of the cyanoacrylate-based UV absorbing agent include 2-ethylhexyl-2-cyano-3,3′-diphenyl acrylate, and ethyl-2-cyano-3,3′-diphenyl acrylate.

Examples of the light stabilizer include a hindered amine-based light stabilizer and a UV stabilizer.

Examples of the hindered amine-based light stabilizer may include bis(2,2,6,6-tetramethyl-4-piperidyl)sebacate, bis(1,2,2,6,6-pentamethyl-4-piperidyl)sebacate, and methyl 1,2,2,6,6-pentamethyl-4-piperidyl sebacate.

Examples of the UV stabilizer include nickel bis(octylphenyl)sulfide, [2,2′-thiobis(4-tert-octylphenolate)]-n-butylaminenickel, nickel complex-3,5-di-tert-butyl-4-hydroxybenzyl-phosphoric acid monoethylate, a benzoate-type quencher, and nickel dibutyldithiocarbamate.

The deterioration-preventing agent which the polyurethane-based resin in the present invention contains is preferably a deterioration-preventing agent having a hindered phenol structure. When the deterioration-preventing agent which the polyurethane-based resin in the present invention contains is the deterioration-preventing agent having a hindered phenol structure, the content of the deterioration-preventing agent having a hindered phenol structure is preferably 0.01 wt % to 10 wt %, more preferably 0.05 wt % to 10 wt %, still more preferably 0.1 wt % to 10 wt % with respect to the polyol (A). Adjusting the content of the deterioration-preventing agent having a hindered phenol structure within the range can make the pressure-sensitive adhesive additionally excellent in adhesive residue-preventing property. Specifically, even when the pressure-sensitive adhesive is stored in a warmed state after having been attached to an adherend, an adhesive residue occurs on the adherend in an additionally hard manner. When the content of the deterioration-preventing agent having a hindered phenol structure is excessively small, it may become impossible to express the adhesive residue-preventing property sufficiently. When the content of the deterioration-preventing agent having a hindered phenol structure is excessively large, the following problems may arise: a disadvantage in terms of cost appears, pressure-sensitive adhesive characteristics cannot be maintained, or the adherend is contaminated.

Any appropriate deterioration-preventing agent can be adopted as the deterioration-preventing agent having a hindered phenol structure as long as the deterioration-preventing agent has, for example, a hindered phenol structure in which a group having large steric hindrance such as a tertiary butyl group is bonded to at least one of the carbon atoms adjacent to the carbon atom on the aromatic ring of phenol to which an OH group is bonded. The use of a specific deterioration-preventing agent that is a deterioration-preventing agent having such hindered phenol structure may extremely enlarge a suppressing effect on a reduction in molecular weight of the polyol as compared with the conventional one, and hence the pressure-sensitive adhesive can express the following effect: its adhesive residue-preventing property is markedly excellent as compared with the conventional one.

Specific examples of the deterioration-preventing agent having the hindered phenol structure as described above include: dibutylhydroxytoluene (BHT); hindered phenol-based antioxidants such as ones available under the trade name “IRGANOX 1010” (manufactured by BASF), the trade name “IRGANOX 1010FF” (manufactured by BASF), the trade name “IRGANOX 1035” (manufactured by BASF), the trade name “IRGANOX 1035FF” (manufactured by BASF), the trade name “IRGANOX 1076” (manufactured by BASF), the trade name “IRGANOX 1076FD” (manufactured by BASF), the trade name “IRGANOX 1076DWJ” (manufactured by BASF), the trade name “IRGANOX 1098” (manufactured by BASF), the trade name “IRGANOX 1135” (manufactured by BASF), the trade name “IRGANOX 1330” (manufactured by BASF), the trade name “IRGANOX 1726” (manufactured by BASF), the trade name “IRGANOX 1425WL” (manufactured by BASF), the trade name “IRGANOX 1520L” (manufactured by BASF), the trade name “IRGANOX 245” (manufactured by BASF), the trade name “IRGANOX 245FF” (manufactured by BASF), the trade name “IRGANOX 259” (manufactured by BASF), the trade name “IRGANOX 3114” (manufactured by BASF), the trade name “IRGANOX 565” (manufactured by BASF), the trade name “IRGANOX 295” (manufactured by BASF), and the trade name “IRGANOX E201” (manufactured by BASF); benzotriazole-based UV absorbing agents such as ones available under the trade name “TINUVIN P” (manufactured by BASF), the trade name “TINUVIN P FL” (manufactured by BASF), the trade name “TINUVIN 234” (manufactured by BASF), the trade name “TINUVIN 326” (manufactured by BASF), the trade name “TINUVIN 326FL” (manufactured by BASF), the trade name “TINUVIN 328” (manufactured by BASF), the trade name “TINUVIN 329” (manufactured by BASF), and the trade name “TINUVIN 329FL” (manufactured by BASF); liquid UV absorbing agents such as ones available under the trade name “TINUVIN 213” (manufactured by BASF) and the trade name “TINUVIN 571” (manufactured by BASF); triazine-based UV absorbing agents such as one available under the trade name “TINUVIN 1577ED” (manufactured by BASF); benzoate-based UV absorbing agents such as one available under the trade name “TINUVIN 120” (manufactured by BASF); and hindered amine-based light stabilizer such as one available under the trade name “TINUVIN 144” (manufactured by BASF).

A deterioration-preventing agent having no hindered phenol structure can be used as the deterioration-preventing agent which the polyurethane-based resin in the present invention contains. In this case, appropriately selecting the kind of a catalyst (described later) to be adopted can make the pressure-sensitive adhesive to express the adhesive residue-preventing property sufficiently. When the deterioration-preventing agent which the polyurethane-based resin in the present invention contains is the deterioration-preventing agent having no hindered phenol structure, the content of the deterioration-preventing agent having no hindered phenol structure is preferably 0.01 wt % to 10 wt %, more preferably 0.05 wt % to 10 wt %, still more preferably 0.1 wt % to 10 wt % with respect to the polyol (A). Adjusting the content of the deterioration-preventing agent having no hindered phenol structure within the range can make the pressure-sensitive adhesive additionally excellent in adhesive residue-preventing property. Specifically, even when the pressure-sensitive adhesive is stored in a warmed state after having been attached to an adherend, an adhesive residue occurs on the adherend in an additionally hard manner. When the content of the deterioration-preventing agent having no hindered phenol structure is excessively small, it may become impossible to express the adhesive residue-preventing property sufficiently. When the content of the deterioration-preventing agent having no hindered phenol structure is excessively large, the following problems may arise: a disadvantage in terms of cost appears, pressure-sensitive adhesive characteristics cannot be maintained, or the adherend is contaminated.

Specific examples of the deterioration-preventing agent having no hindered phenol structure as described above include: hindered amine-based light stabilizers such as one available under trade name “TINUVIN 765” (manufactured by BASF); 1,4-diazabicyclo[2.2.2]octane; and bis(2,6-diisopropylphenyl)carbodiimide.

The content of the polyfunctional isocyanate compound (B) is preferably 5 wt % to 60 wt %, more preferably 8 wt % to 60 wt %, still more preferably 10 wt % to 60 wt % with respect to the polyol (A). When the content of the polyfunctional isocyanate compound (B) is adjusted within the range, there can be provided a urethane-based pressure-sensitive adhesive excellent in reworkability, initial wettability, and transparency.

An equivalent ratio “NCO group/OH group” between NCO groups and OH groups in the polyol (A) and the polyfunctional isocyanate compound (B) is preferably 1.0 to 5.0, more preferably 1.2 to 4.0, still more preferably 1.5 to 3.5, particularly preferably 1.8 to 3.0. When the equivalent ratio “NCO group/OH group” is adjusted within the range, there can be provided a urethane-based pressure-sensitive adhesive excellent in reworkability, initial wettability, and transparency.

Any appropriate method such as a urethane-forming reaction method involving using bulk polymerization, solution polymerization, or the like may be adopted as a method of obtaining the polyurethane-based resin by curing the composition containing the polyol (A) and the polyfunctional isocyanate compound (B) as long as the effects of the present invention are not impaired.

In order to cure the composition containing the polyol (A) and the polyfunctional isocyanate compound (B), a catalyst is preferably used. Examples of such catalyst include an organometallic compound and a tertiary amine compound.

Examples of the organometallic compound may include an iron-based compound, a tin-based compound, a titanium-based compound, a zirconium-based compound, a lead-based compound, a cobalt-based compound, and a zinc-based compound. Of those, an iron-based compound and a tin-based compound are preferred from the viewpoints of a reaction rate and the pot life of the pressure-sensitive adhesive layer.

Examples of the iron-based compound include iron acetylacetonate and iron 2-ethylhexanoate.

Examples of the tin-based compound include dibutyltin dichloride, dibutyltin oxide, dibutyltin dibromide, dibutyltin maleate, dibutyltin dilaurate, dibutyltin diacetate, dibutyltin sulfide, tributyltin methoxide, tributyltin acetate, triethyltin ethoxide, tributyltin ethoxide, dioctyltin oxide, dioctyltin dilaurate, tributyltin chloride, tributyltin trichloroacetate, and tin 2-ethylhexanoate.

Examples of the titanium-based compound include dibutyltitanium dichloride, tetrabutyl titanate, and butoxytitanium trichloride.

Examples of the zirconium-based compound include zirconium naphthenate and zirconium acetylacetonate.

Examples of the lead-based compound include lead oleate, lead 2-ethylhexanoate, lead benzoate, and lead naphthenate.

Examples of the cobalt-based compound include cobalt 2-ethylhexanoate and cobalt benzoate.

Examples of the zinc-based compound include zinc naphthenate and zinc 2-ethylhexanoate.

Examples of the tertiary amine compound include triethylamine, triethylenediamine, and 1,8-diazabicyclo[5.4.0]undec-7-ene.

The number of kinds of the catalysts may be only one, or may be two or more. In addition, the catalyst may be used in combination with a cross-linking retardant or the like. The amount of the catalyst is preferably 0.02 wt % to 0.10 wt %, more preferably 0.02 wt % to 0.08 wt %, still more preferably 0.02 wt % to 0.06 wt %, particularly preferably 0.02 wt % to 0.05 wt % with respect to the polyol (A). When the amount of the catalyst is adjusted within the range, there can be provided a urethane-based pressure-sensitive adhesive excellent in reworkability, initial wettability, and transparency.

The urethane-based pressure-sensitive adhesive of the present invention may contain any appropriate other component in addition to the polyurethane-based resin as described above as long as the effects of the present invention are not impaired. Examples of such other component include a resin component other than the polyurethane-based resin, a tackifier, an inorganic filler, an organic filler, metal powder, a pigment, a foil-shaped material, a softener, a plasticizer, an age resistor, a conductive agent, a UV absorbing agent, an antioxidant, alight stabilizer, a surface lubricating agent, a leveling agent, a corrosion inhibitor, a heat stabilizer, a polymerization inhibitor, a lubricant, and a solvent.

The urethane-based pressure-sensitive adhesive of the present invention has an adhesion to a glass plate of preferably 0.5 N/25 mm or less, more preferably 0.005 N/25 mm to 0.5 N/25 mm, still more preferably 0.005 N/25 mm to 0.4 N/25 mm, particularly preferably 0.005 N/25 mm to 0.3 N/25 mm, most preferably 0.01 N/25 mm to 0.2 N/25 mm in terms of an initial adhesion immediately after its attachment to the glass plate. When the initial adhesion falls within the range, the urethane-based pressure-sensitive adhesive of the present invention has moderate initial pressure-sensitive adhesiveness and hence can express additionally excellent reworkability.

It should be noted that the measurement of the initial adhesion can be performed as described below. A surface protective film having a pressure-sensitive adhesive layer containing the urethane-based pressure-sensitive adhesive of the present invention is cut into a sample for an evaluation having a width of 25 mm and a length of 150 mm. The pressure-sensitive adhesive layer surface of the sample for an evaluation is attached to a glass plate (manufactured by Matsunami Glass Ind., Ltd., trade name: Micro Slide Glass S) by reciprocating a 2.0-kg roller once under an atmosphere having a temperature of 23° C. and a humidity of 50% RH, followed by aging under the atmosphere having a temperature of 23° C. and a humidity of 50% RH for 30 minutes. After that, the sample is measured for its adhesion by being peeled with a universal tensile tester (manufactured by Minebea Co., Ltd., product name: TCM-1kNB) at a peel angle of 180° and a rate of pulling of 300 mm/min.

The urethane-based pressure-sensitive adhesive of the present invention has an adhesion to a glass plate of preferably 0.5 N/25 mm or less, more preferably 0.005 N/25 mm to 0.5 N/25 mm, still more preferably 0.005 N/25 mm to 0.4 N/25 mm, particularly preferably 0.005 N/25 mm to 0.3 N/25 mm, most preferably 0.01 N/25 mm to 0.2 N/25 mm after being attached to the glass plate and stored at 50° C. and 50% RH for 3 days. When the adhesion falls within the range, the urethane-based pressure-sensitive adhesive of the present invention can express additionally excellent reworkability.

It should be noted that the measurement of the adhesion can be performed by: producing a sample for an evaluation by the same method as that in the case of the initial adhesion to the glass plate; and measuring the adhesion of the sample after its storage at a temperature of 50° C. and a humidity of 50% RH for 3 days by the same method as that in the case of the initial adhesion.

The urethane-based pressure-sensitive adhesive of the present invention has an adhesion to a glass plate of preferably 0.5 N/25 mm or less, more preferably 0.005 N/25 mm to 0.5 N/25 mm, still more preferably 0.005 N/25 mm to 0.4 N/25 mm, particularly preferably 0.005 N/25 mm to 0.3 N/25 mm, most preferably 0.01 N/25 mm to 0.2 N/25 mm after being attached to the glass plate and stored at 60° C. and 92% RH for 3 days. When the adhesion falls within the range, the urethane-based pressure-sensitive adhesive of the present invention can express additionally excellent reworkability.

It should be noted that the measurement of the adhesion can be performed by: producing a sample for an evaluation by the same method as that in the case of the initial adhesion to the glass plate; and measuring the adhesion of the sample after its storage at a temperature of 60° C. and a humidity of 92% RH for 3 days by the same method as that in the case of the initial adhesion.

The urethane-based pressure-sensitive adhesive of the present invention has an adhesion to a glass plate of preferably 0.5 N/25 mm or less, more preferably 0.005 N/25 mm to 0.5 N/25 mm, still more preferably 0.005 N/25 mm to 0.4 N/25 mm, particularly preferably 0.005 N/25 mm to 0.3 N/25 mm, most preferably 0.01 N/25 mm to 0.2 N/25 mm under anyone of the following conditions: immediately after the attachment to the glass plate, after being attached to the glass plate and stored at 50° C. and 50% RH for 3 days, and after being attached to the glass plate and stored at 60° C. and 92% RH for 3 days. When the adhesion falls within the range, the urethane-based pressure-sensitive adhesive of the present invention can express additionally excellent reworkability.

The urethane-based pressure-sensitive adhesive of the present invention preferably has high transparency. When the urethane-based pressure-sensitive adhesive of the present invention has high transparency, an inspection or the like can be accurately performed in a state where the pressure-sensitive adhesive is attached to the surface of an optical member or electronic member. The urethane-based pressure-sensitive adhesive of the present invention has a haze of preferably 5% or less, more preferably 4% or less, still more preferably 3% or less, particularly preferably 2% or less, most preferably 1% or less.

It should be noted that the haze was measured with a haze meter HM-150 (manufactured by MURAKAMI COLOR RESEARCH LABORATORY CO., LTD.) in conformity with JIS-K-7136 and calculated on the basis of the following equation: haze (%)=(Td/Tt)×100 (Td: diffuse transmittance, Tt: total light transmittance).

<<B. Surface Protective Film>>

A surface protective film of the present invention is a surface protective film to be preferably used in the surface protection of an optical member or electronic member. The surface protective film of the present invention has a base material layer and a pressure-sensitive adhesive layer, and the pressure-sensitive adhesive layer contains the urethane-based pressure-sensitive adhesive of the present invention.

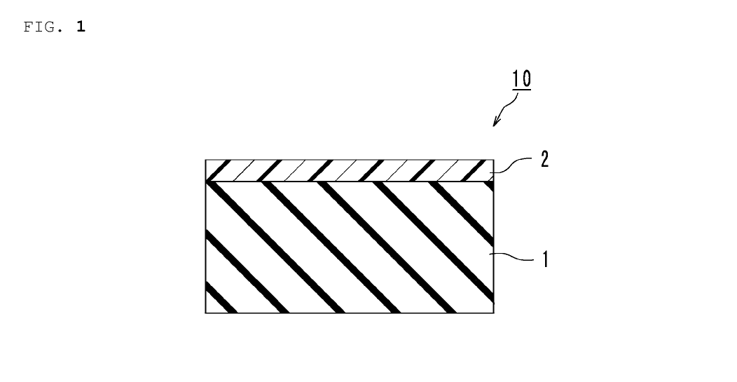

FIG. 1 is a schematic sectional view of a surface protective film according to a preferred embodiment of the present invention. A surface protective film 10 has a base material layer 1 and a pressure-sensitive adhesive layer 2. The surface protective film of the present invention may further have any appropriate other layer (not shown) as required.

The surface of the base material layer 1 on which the pressure-sensitive adhesive layer 2 is not provided can, for example, be subjected to a release treatment through the addition of a fatty acid amide, a polyethyleneimine, a long-chain alkyl-based additive, or the like to the base material layer, or be provided with a coat layer formed of any appropriate releasing agent such as a silicone-, long-chain alkyl-, or fluorine-based releasing agent for the purpose of, for example, forming a roll body that can be easily rewound.

A release liner having releasability may be attached to the surface protective film of the present invention.

The thickness of the surface protective film of the present invention can be set to any appropriate thickness depending on applications. The thickness is preferably 10 μm to 300 μm, more preferably 15 μm to 250 μm, still more preferably 20 μm to 200 μm, particularly preferably 25 μm to 150 μm from the viewpoint of sufficiently expressing the effects of the present invention.

The pressure-sensitive adhesive layer of the surface protective film of the present invention has an adhesion to a glass plate of preferably 0.5 N/25 mm or less, more preferably 0.005 N/25 mm to 0.5 N/25 mm, still more preferably 0.005 N/25 mm to 0.4 N/25 mm, particularly preferably 0.005 N/25 mm to 0.3 N/25 mm, most preferably 0.01 N/25 mm to 0.2 N/25 mm in terms of an initial adhesion immediately after its attachment to the glass plate. When the initial adhesion falls within the range, the surface protective film of the present invention has moderate initial pressure-sensitive adhesiveness and hence can express additionally excellent reworkability. It should be noted that the measurement of the initial adhesion is the same as described above.

The pressure-sensitive adhesive layer of the surface protective film of the present invention has an adhesion to a glass plate of preferably 0.5 N/25 mm or less, more preferably 0.005 N/25 mm to 0.5 N/25 mm, still more preferably 0.005 N/25 mm to 0.4 N/25 mm, particularly preferably 0.005 N/25 mm to 0.3 N/25 mm, most preferably 0.01 N/25 mm to 0.2 N/25 mm after being attached to the glass plate and stored at 50° C. and 50% RH for 3 days. When the adhesion falls within the range, the surface protective film of the present invention can express additionally excellent reworkability. It should be noted that the measurement of the adhesion is the same as described above.

The pressure-sensitive adhesive layer of the surface protective film of the present invention has an adhesion to a glass plate of preferably 0.5 N/25 mm or less, more preferably 0.005 N/25 mm to 0.5 N/25 mm, still more preferably 0.005 N/25 mm to 0.4 N/25 mm, particularly preferably 0.005 N/25 mm to 0.3 N/25 mm, most preferably 0.01 N/25 mm to 0.2 N/25 mm after being attached to the glass plate and stored at 60° C. and 92% RH for 3 days. When the adhesion falls within the range, the surface protective film of the present invention can express additionally excellent reworkability. It should be noted that the measurement of the adhesion is the same as described above.

The pressure-sensitive adhesive layer of the surface protective film of the present invention has an adhesion to a glass plate of preferably 0.5 N/25 mm or less, more preferably 0.005 N/25 mm to 0.5 N/25 mm, still more preferably 0.005 N/25 mm to 0.4 N/25 mm, particularly preferably 0.005 N/25 mm to 0.3 N/25 mm, most preferably 0.01 N/25 mm to 0.2 N/25 mm under any one of the following conditions: immediately after the attachment to the glass plate, after being attached to the glass plate and stored at 50° C. and 50% RH for 3 days, and after being attached to the glass plate and stored at 60° C. and 92% RH for 3 days. When the adhesion falls within the range, the surface protective film of the present invention can express additionally excellent reworkability.

The surface protective film of the present invention preferably has high transparency. When the surface protective film of the present invention has high transparency, inspection or the like can be accurately performed under a state in which the film is attached to the surface of an optical member or an electronic member. The surface protective film of the present invention has a haze of preferably 5% or less, more preferably 4% or less, still more preferably 3% or less, particularly preferably 2% or less, most preferably 1% or less. It should be noted that the measurement of the haze is the same as described above.

<B-1. Pressure-Sensitive Adhesive Layer>

The pressure-sensitive adhesive layer contains the urethane-based pressure-sensitive adhesive of the present invention. The content of the urethane-based pressure-sensitive adhesive of the present invention in the pressure-sensitive adhesive layer is preferably 50 wt % to 100 wt %, more preferably 70 wt % to 100 wt %, still more preferably 90 wt % to 100 wt %, particularly preferably 95 wt % to 100 wt %, most preferably 98 wt % to 100 wt %. Adjusting the content of the urethane-based pressure-sensitive adhesive of the present invention in the pressure-sensitive adhesive layer within the range can provide a surface protective film extremely excellent in adhesive residue-preventing property.

Any appropriate thickness can be adopted as the thickness of the pressure-sensitive adhesive layer depending on applications. The thickness of the pressure-sensitive adhesive layer is preferably 1 μm to 100 μm, more preferably 3 μm to 50 μm, still more preferably 5 μm to 30 μm.

The pressure-sensitive adhesive layer may be manufactured by any appropriate manufacturing method. An example of such manufacturing method is a method involving applying a composition that is a material for forming the pressure-sensitive adhesive layer onto the base material layer to form the pressure-sensitive adhesive layer on the base material layer. Examples of such application method include roll coating, gravure coating, reverse coating, roll brushing, spray coating, air knife coating, and extrusion coating with a die coater.

<B-2. Base Material Layer>

Any appropriate thickness can be adopted as the thickness of the base material layer depending on applications. The thickness of the base material layer is preferably 5 μm to 300 μm, more preferably 10 μm to 250 μm, still more preferably 15 μm to 200 μm, particularly preferably 20 μm to 150 μm.

The base material layer may be a single layer, or may be a laminate of two or more layers. The base material layer may be stretched.

Any appropriate material can be adopted as a material for the base material layer depending on applications. Examples thereof include a plastic, paper, a metal film, and a nonwoven fabric. Of those, the plastic is preferred. The base material layer may be constituted of one kind of material, or may be constituted of two or more kinds of materials. For example, the layer may be constituted of two or more kinds of plastics.

Examples of the plastic include a polyester-based resin, a polyamide-based resin, and a polyolefin-based resin. Examples of the polyester-based resin include a polyethylene terephthalate, a polybutylene terephthalate, and a polyethylene naphthalate. Examples of the polyolefin-based resin include a homopolymer of an olefin monomer and a copolymer of an olefin monomer. Specific examples of the polyolefin-based resin include: a homo-polypropylene; a propylene-based copolymer using an ethylene component as a copolymerization component such as a block-, random-, or graft-based copolymer; a reactor TPO; an ethylene-based polymer such as a low-density, high-density, linear and low-density, or ultralow-density polymer; and an ethylene-based copolymer such as an ethylene-propylene copolymer, an ethylene-vinyl acetate copolymer, an ethylene-methyl acrylate copolymer, an ethylene-ethyl acrylate copolymer, an ethylene-butyl acrylate copolymer, an ethylene-methacrylic acid copolymer, or an ethylene-methyl methacrylate copolymer.

The base material layer can contain any appropriate additive as required. Examples of the additive that can be incorporated into the base material layer include an antioxidant, a UV absorbing agent, a light stabilizer, an antistatic agent, a filler, and a pigment. The kinds, number, and amount of the additives that can be incorporated into the base material layer can be appropriately set depending on purposes. In particular, when the material for the base material layer is a plastic, several of the additives are preferably incorporated for the purpose of, for example, deterioration prevention. From the viewpoint of, for example, an improvement in weatherability, particularly preferred examples of the additive include an antioxidant, a UV absorbing agent, a light stabilizer, and a filler.

Any appropriate antioxidant can be adopted as the antioxidant. Examples of such antioxidant include a phenol-based antioxidant, a phosphorus-based processing heat stabilizer, a lactone-based processing heat stabilizer, a sulfur-based heat stabilizer, and a phenol-phosphorus-based antioxidant. The content of the antioxidant is preferably 1 wt % or less, more preferably 0.5 wt % or less, still more preferably 0.01 wt % to 0.2 wt % with respect to the base resin of the base material layer (when the base material layer is a blend, the blend is the base resin).

Any appropriate UV absorbing agent can be adopted as the UV absorbing agent. Examples of such UV absorbing agent include a benzotriazole-based UV absorbing agent, a triazine-based UV absorbing agent, and a benzophenone-based UV absorbing agent. The content of the UV absorbing agent is preferably 2 wt % or less, more preferably 1 wt % or less, still more preferably 0.01 wt % to 0.5 wt % with respect to the base resin forming the base material layer (when the base material layer is a blend, the blend is the base resin).

Any appropriate light stabilizer can be adopted as the light stabilizer. Examples of such light stabilizer include a hindered amine-based light stabilizer and a benzoate-based light stabilizer. The content of the light stabilizer is preferably 2 wt % or less, more preferably 1 wt % or less, still more preferably 0.01 wt % to 0.5 wt % with respect to the base resin forming the base material layer (when the base material layer is a blend, the blend is the base resin).

Any appropriate filler can be adopted as the filler. Examples of such filler include inorganic fillers. Specific examples of the inorganic fillers include carbon black, titanium oxide, and zinc oxide. The content of the filler is preferably 20 wt % or less, more preferably 10 wt % or less, still more preferably 0.01 wt % to 10 wt % with respect to the base resin forming the base material layer (when the base material layer is a blend, the blend is the base resin).

Preferred examples of the additive further include inorganic, low-molecular weight-based, and high-molecular weight-based antistatic agents such as a surfactant, an inorganic salt, a polyhydric alcohol, a metal compound, and carbon intended to impart antistatic property. Of those, a high-molecular weight-based antistatic agent and carbon are preferred from the viewpoints of contamination and the maintenance of pressure-sensitive adhesiveness.

<B-3. Method of Manufacturing Surface Protective Film>

The surface protective film of the present invention may be manufactured by any appropriate method. Such manufacturing method may be performed in conformity with any appropriate manufacturing method such as:

(1) a method involving applying a solution or heat-melt of a material for forming the pressure-sensitive adhesive layer (e.g., a composition containing the polyol (A) and the polyfunctional isocyanate compounds (B), which is a raw material for the urethane-based pressure-sensitive adhesive of the present invention) onto the base material layer;
(2) a method in accordance with the method (1) involving applying the solution or heat-melt onto a separator, and transferring the formed pressure-sensitive adhesive layer onto the base material layer;
(3) a method involving extruding a material for forming the pressure-sensitive adhesive layer onto the base material layer, and forming the layer by application;
(4) a method involving extruding the base material layer and the pressure-sensitive adhesive layer in two or more layers;
(5) a method involving laminating the base material layer with a single layer, i.e., the pressure-sensitive adhesive layer or a method involving laminating the base material layer with two layers, i.e., the pressure-sensitive adhesive layer and a laminate layer; or
(6) a method involving forming the pressure-sensitive adhesive layer and a material for forming the base material layer such as a film or a laminate layer into a laminate of two or more layers.

<<C. Application>>

The urethane-based pressure-sensitive adhesive of the present invention can be used in any appropriate application. The urethane-based pressure-sensitive adhesive of the present invention is preferably used as the pressure-sensitive adhesive layer of a surface protective film because the pressure-sensitive adhesive is extremely excellent in adhesive residue-preventing property. With such procedure, the surface protective film can be suitably used in the surface protection of an optical member or electronic member. The optical member or electronic member to which the surface protective film of the present invention is attached can be manually attached and peeled any number of times.

### EXAMPLES

Hereinafter, the present invention is described specifically by way of Examples. However, the present invention is by no means limited to Examples. It should be noted that test and evaluation methods in Examples and the like are as described below. It should be noted that the term “part(s)” in the following description means “part(s) by weight” unless otherwise specified, and the term “%” in the following description means “wt %” unless otherwise specified.

<Production of Sample for Adhesive Residue Evaluation>

A surface protective film was cut into a sample for an evaluation having a width of 25 mm and a length of 150 mm.

The pressure-sensitive adhesive layer surface of the sample for an evaluation was attached to a glass plate (manufactured by Matsunami Glass Ind., Ltd., trade name: Micro Slide Glass S) by reciprocating a 2.0-kg roller once under an atmosphere having a temperature of 23° C. and a humidity of 50% RH.

<Evaluation for Adhesive Residue 7 Days after Storage at 50° C. and 50% RH>

The sample for an evaluation was stored at a temperature of 50° C. and a humidity of 50% RH for 7 days. After that, the sample for an evaluation was peeled at a rate of 0.3 m/min and then an evaluation for an adhesive residue was performed in accordance with the following criteria.

o: No adhesive residue occurs on the adherend.
Δ: The adhesive residue occurs on part of the adherend.
x: The adhesive residue occurs on the entire surface of the adherend.

<Evaluation for Adhesive Residue 7 Days after Storage at 60° C. and 90% RH>

The sample for an evaluation was stored at a temperature of 60° C. and a humidity of 90% RH for 7 days. After that, the sample for an evaluation was peeled at a rate of 0.3 m/min and then an evaluation for an adhesive residue was performed in accordance with the following criteria.

o: No adhesive residue occurs on the adherend.
Δ: The adhesive residue occurs on part of the adherend.
x: The adhesive residue occurs on the entire surface of the adherend.

<Evaluation for Adhesive Residue 7 Days after Storage at 85° C. and 50% RH>

The sample for an evaluation was stored at a temperature of 85° C. and a humidity of 50% RH for 7 days. After that, the sample for an evaluation was peeled at a rate of 0.3 m/min and then an evaluation for an adhesive residue was performed in accordance with the following criteria.

o: No adhesive residue occurs on the adherend.
Δ: The adhesive residue occurs on part of the adherend.
x: The adhesive residue occurs on the entire surface of the adherend.

<Evaluation for Adhesive Residue 1 Hour after Storage at 100° C. and 50% RH>

The sample for an evaluation was stored at a temperature of 100° C. and a humidity of 50% RH for 1 hour. After that, the sample for an evaluation was peeled at a rate of 0.3 m/min and then an evaluation for an adhesive residue was performed in accordance with the following criteria.

o: No adhesive residue occurs on the adherend.
Δ: The adhesive residue occurs on part of the adherend.
x: The adhesive residue occurs on the entire surface of the adherend.

<Evaluation for Adhesive Residue 1 Hour after Storage at 130° C. and 50% RH>

The sample for an evaluation was stored at a temperature of 130° C. and a humidity of 50% RH for 1 hour. After that, the sample for an evaluation was peeled at a rate of 0.3 m/min and then an evaluation for an adhesive residue was performed in accordance with the following criteria.

o: No adhesive residue occurs on the adherend.
Δ: The adhesive residue occurs on part of the adherend.
x: The adhesive residue occurs on the entire surface of the adherend.

<Evaluation for Adhesive Residue 1 Hour after Storage at 150° C. and 50% RH>

The sample for an evaluation was stored at a temperature of 150° C. and a humidity of 50% RH for 1 hour. After that, the sample for an evaluation was peeled at a rate of 0.3 m/min and then an evaluation for an adhesive residue was performed in accordance with the following criteria.

o: No adhesive residue occurs on the adherend.
Δ: The adhesive residue occurs on part of the adherend.
x: The adhesive residue occurs on the entire surface of the adherend.

<Measurement of Number-Average Molecular Weight Reduction Ratio of Polyol>

In each of examples and comparative examples, a predetermined amount of a blend from which a cross-linking agent had been removed was weighed in an aluminum cup, and was then heated under the conditions of a temperature of 130° C. and a time period of 1 hour. After the heating, the resultant blend was dissolved in tetrahydrofuran and then its number-average molecular weight was measured by using a gel permeation chromatography apparatus (manufactured by TOSOH CORPORATION). In addition, the number-average molecular weight of the blend before the heating was measured as a reference with the measuring apparatus, and then a reduction ratio was calculated from an equation “number-average molecular weight reduction ratio (%)=(1−(number-average molecular weight of blend after heating)/(number-average molecular weight of blend before heating))×100” It should be noted that upon measurement of each number-average molecular weight, the number-average molecular weight of each sample was measured after a molecular weight-elution time calibration curve had been created in advance with a polystyrene having a known molecular weight by measuring the elution time of the polystyrene.

### Example 1

100 Parts by weight of a PREMINOL S3011 (manufactured by ASAHI GLASS CO., LTD., Mn=10,000), which was a polyol having three OH groups, as the polyol (A), 12 parts by weight of a CORONATE HX (manufactured by Nippon Polyurethane Industry Co., Ltd.), which was a polyfunctional alicyclic isocyanate compound, as the polyfunctional isocyanate compound (B), 0.04 part by weight of a catalyst (manufactured by NIHON KAGAKU SANGYO CO., LTD., trade name: NacemFerric Iron), 0.5 part by weight of an Irganox 1010 (manufactured by BASF) as a deterioration-preventing agent, and 210 parts by weight of ethyl acetate as a diluent solvent were compounded and then stirred with a disper to provide a urethane-based pressure-sensitive adhesive composition. The resultant urethane-based pressure-sensitive adhesive composition was applied to a base material “Lumirror S10” formed of a polyester resin (thickness: 38 μm, manufactured by Toray Industries, Inc.) with a fountain roll so that its thickness after drying became 12 μm, and then the composition was cured and dried under the conditions of a drying temperature of 130° C. and a drying time of 2 minutes. Thus, a pressure-sensitive adhesive layer formed of a urethane-based pressure-sensitive adhesive (1) was produced on the base material.

Next, the silicone-treated surface of a base material formed of a polyester resin having a thickness of 25 μm one surface of which had been subjected to a silicone treatment was attached to the surface of the pressure-sensitive adhesive layer to provide a surface protective film (1).

Table 1 shows the results of the evaluations.

### Example 2

A pressure-sensitive adhesive layer formed of a urethane-based pressure-sensitive adhesive (2) was produced on the base material in the same manner as in Example 1 except that 0.08 part by weight of an EMBILIZER OL-1 (dioctyltin dilaurate-based catalyst, manufactured by Tokyo Fine Chemical CO., LTD.) was used as a catalyst.

Next, the silicone-treated surface of a base material formed of a polyester resin having a thickness of 25 μm one surface of which had been subjected to a silicone treatment was attached to the surface of the pressure-sensitive adhesive layer to provide a surface protective film (2).

Table 1 shows the results of the evaluations.

### Example 3

A pressure-sensitive adhesive layer formed of a urethane-based pressure-sensitive adhesive (3) was produced on the base material in the same manner as in Example 1 except that 0.5 part by weight of dibutylhydroxytoluene (manufactured by Tokyo Chemical Industry Co., Ltd.) was used as a deterioration-preventing agent.

Next, the silicone-treated surface of a base material formed of a polyester resin having a thickness of 25 μm one surface of which had been subjected to a silicone treatment was attached to the surface of the pressure-sensitive adhesive layer to provide a surface protective film (3).

Table 1 shows the results of the evaluations.

### Example 4

A pressure-sensitive adhesive layer formed of a urethane-based pressure-sensitive adhesive (4) was produced on the base material in the same manner as in Example 3 except that 0.08 part by weight of an EMBILIZER OL-1 (dioctyltin dilaurate-based catalyst, manufactured by Tokyo Fine Chemical CO., LTD.) was used as a catalyst.

Next, the silicone-treated surface of a base material formed of a polyester resin having a thickness of 25 μm one surface of which had been subjected to a silicone treatment was attached to the surface of the pressure-sensitive adhesive layer to provide a surface protective film (4).

Table 1 shows the results of the evaluations.

### Example 5

A pressure-sensitive adhesive layer formed of a urethane-based pressure-sensitive adhesive (5) was produced on the base material in the same manner as in Example 1 except that 0.5 part by weight of a TINUVIN 326 (manufactured by BASF) was used as a deterioration-preventing agent.

Next, the silicone-treated surface of a base material formed of a polyester resin having a thickness of 25 μm one surface of which had been subjected to a silicone treatment was attached to the surface of the pressure-sensitive adhesive layer to provide a surface protective film (5).

Table 1 shows the results of the evaluations.

### Example 6

A pressure-sensitive adhesive layer formed of a urethane-based pressure-sensitive adhesive (6) was produced on the base material in the same manner as in Example 5 except that 0.08 part by weight of an EMBILIZER OL-1 (dioctyltin dilaurate-based catalyst, manufactured by Tokyo Fine Chemical CO., LTD.) was used as a catalyst.

Next, the silicone-treated surface of a base material formed of a polyester resin having a thickness of 25 μm one surface of which had been subjected to a silicone treatment was attached to the surface of the pressure-sensitive adhesive layer to provide a surface protective film (6).

Table 1 shows the results of the evaluations.

### Example 7

A pressure-sensitive adhesive layer formed of a urethane-based pressure-sensitive adhesive (7) was produced on the base material in the same manner as in Example 2 except that 0.5 part by weight of an Irganox 1135 (manufactured by BASF) was used as a deterioration-preventing agent.

Next, the silicone-treated surface of a base material formed of a polyester resin having a thickness of 25 μm one surface of which had been subjected to a silicone treatment was attached to the surface of the pressure-sensitive adhesive layer to provide a surface protective film (7).

Table 2 shows the results of the evaluations.

### Example 8

A pressure-sensitive adhesive layer formed of a urethane-based pressure-sensitive adhesive (8) was produced on the base material in the same manner as in Example 2 except that 0.5 part by weight of an Irganox 1520 L (manufactured by BASF) was used as a deterioration-preventing agent.

Next, the silicone-treated surface of a base material formed of a polyester resin having a thickness of 25 μm one surface of which had been subjected to a silicone treatment was attached to the surface of the pressure-sensitive adhesive layer to provide a surface protective film (8).

Table 2 shows the results of the evaluations.

### Example 9

A pressure-sensitive adhesive layer formed of a urethane-based pressure-sensitive adhesive (9) was produced on the base material in the same manner as in Example 2 except that 0.5 part by weight of an Irganox E201 (manufactured by BASF) was used as a deterioration-preventing agent.

Next, the silicone-treated surface of a base material formed of a polyester resin having a thickness of 25 μm one surface of which had been subjected to a silicone treatment was attached to the surface of the pressure-sensitive adhesive layer to provide a surface protective film (9).

Table 2 shows the results of the evaluations.

### Example 10

A pressure-sensitive adhesive layer formed of a urethane-based pressure-sensitive adhesive (10) was produced on the base material in the same manner as in Example 2 except that 0.5 part by weight of an Irganox 1726 (manufactured by BASF) was used as a deterioration-preventing agent.

Next, the silicone-treated surface of a base material formed of a polyester resin having a thickness of 25 μm one surface of which had been subjected to a silicone treatment was attached to the surface of the pressure-sensitive adhesive layer to provide a surface protective film (10).

Table 2 shows the results of the evaluations.

### Example 11

A pressure-sensitive adhesive layer formed of a urethane-based pressure-sensitive adhesive (11) was produced on the base material in the same manner as in Example 2 except that 0.5 part by weight of a TINUVIN 765 (manufactured by BASF) was used as a deterioration-preventing agent.

Next, the silicone-treated surface of a base material formed of a polyester resin having a thickness of 25 μm one surface of which had been subjected to a silicone treatment was attached to the surface of the pressure-sensitive adhesive layer to provide a surface protective film (11).

Table 3 shows the results of the evaluations.

### Example 12

A pressure-sensitive adhesive layer formed of a urethane-based pressure-sensitive adhesive (12) was produced on the base material in the same manner as in Example 1 except that 0.5 part by weight of 1,4-diazabicyclo[2.2.2]octane (manufactured by Tokyo Chemical Industry Co., Ltd.) was used as a deterioration-preventing agent.

Next, the silicone-treated surface of a base material formed of a polyester resin having a thickness of 25 μm one surface of which had been subjected to a silicone treatment was attached to the surface of the pressure-sensitive adhesive layer to provide a surface protective film (12).

Table 3 shows the results of the evaluations.

### Example 13

A pressure-sensitive adhesive layer formed of a urethane-based pressure-sensitive adhesive (13) was produced on the base material in the same manner as in Example 1 except that 0.5 part by weight of bis(2,6-diisopropylphenyl)carbodiimide (manufactured by Tokyo Chemical Industry Co., Ltd.) was used as a deterioration-preventing agent.

Next, the silicone-treated surface of a base material formed of a polyester resin having a thickness of 25 μm one surface of which had been subjected to a silicone treatment was attached to the surface of the pressure-sensitive adhesive layer to provide a surface protective film (13).

Table 3 shows the results of the evaluations.

### Comparative Example 1

A pressure-sensitive adhesive layer formed of a urethane-based pressure-sensitive adhesive (C1) was produced on the base material in the same manner as in Example 1 except that no deterioration-preventing agent was used.

Next, the silicone-treated surface of a base material formed of a polyester resin having a thickness of 25 μm one surface of which had been subjected to a silicone treatment was attached to the surface of the pressure-sensitive adhesive layer to provide a surface protective film (C1).

Table 4 shows the results of the evaluations.

### Comparative Example 2

A pressure-sensitive adhesive layer formed of a urethane-based pressure-sensitive adhesive (C2) was produced on the base material in the same manner as in Example 2 except that no deterioration-preventing agent was used.

Next, the silicone-treated surface of a base material formed of a polyester resin having a thickness of 25 μm one surface of which had been subjected to a silicone treatment was attached to the surface of the pressure-sensitive adhesive layer to provide a surface protective film (C2).

Table 4 shows the results of the evaluations.

### Reference Example 1

A pressure-sensitive adhesive layer formed of a urethane-based pressure-sensitive adhesive (R1) was produced on the base material in the same manner as in Example 1 except that 0.5 part by weight of a TINUVIN 765 (manufactured by BASF) was used as a deterioration-preventing agent.

Next, the silicone-treated surface of a base material formed of a polyester resin having a thickness of 25 μm one surface of which had been subjected to a silicone treatment was attached to the surface of the pressure-sensitive adhesive layer to provide a surface protective film (R1).

Table 4 shows the results of the evaluations.

### Reference Example 2

A pressure-sensitive adhesive layer formed of a urethane-based pressure-sensitive adhesive (R2) was produced on the base material in the same manner as in Example 2 except that 0.5 part by weight of 1,4-diazabicyclo[2.2.2]octane (manufactured by Tokyo Chemical Industry Co., Ltd.) was used as a deterioration-preventing agent.

Next, the silicone-treated surface of a base material formed of a polyester resin having a thickness of 25 μm one surface of which had been subjected to a silicone treatment was attached to the surface of the pressure-sensitive adhesive layer to provide a surface protective film (R2).

Table 4 shows the results of the evaluations.

### Reference Example 3

A pressure-sensitive adhesive layer formed of a urethane-based pressure-sensitive adhesive (R3) was produced on the base material in the same manner as in Example 2 except that 0.5 part by weight of bis(2,6-diisopropylphenyl)carbodiimide (manufactured by Tokyo Chemical Industry Co., Ltd.) was used as a deterioration-preventing agent.

Next, the silicone-treated surface of a base material formed of a polyester resin having a thickness of 25 μm one surface of which had been subjected to a silicone treatment was attached to the surface of the pressure-sensitive adhesive layer to provide a surface protective film (R3).

Table 4 shows the results of the evaluations.

TABLE 1

| | | | | Presence or | | | | | | |
|---|---|---|---|---|---|---|---|---|---|---|
| | | | | absence of | | | | | | |
| | | | Number of | hindered | | | | | | |
| | | | functional | phenol | Exam- | | | | | |
| | | Mn | groups | structure | ple 1 | Example 2 | Example 3 | Example 4 | Example 5 | Example 6 |
| Polyol (A) | S3011 | 10,000 | 3 | — | 100 | 100 | 100 | 100 | 100 | 100 |
| Polyfunctional | CORONATE | 504 | 3 | — | 12 | 12 | 12 | 12 | 12 | 12 |
| isocyanate | HX | | | | | | | | | |
| compound (B) | | | | | | | | | | |

| Equivalent | | — | 2 | 2 | 2 | 2 | 2 | 2 |
|---|---|---|---|---|---|---|---|---|
| Catalyst | Nacem Ferric Iron | — | 0.04 | — | 0.04 | — | 0.04 | — |
| | EMBILIZER OL-1 | — | — | 0.08 | — | 0.08 | — | 0.08 |
| Deterioration- | Irganox 1010 | Present | 0.5 | 0.5 | — | — | — | — |
| preventing | Dibutylhydroxytoluene | Present | — | — | 0.5 | 0.5 | — | — |
| agent | TINUVIN 326 | Present | — | — | — | — | 0.5 | 0.5 |
| | TINUVIN 765 | Absent | — | — | — | — | — | — |
| | 1,4-Diazabicyclo[2.2.2]octane | Absent | — | — | — | — | — | — |
| | Bis(2,6- | Absent | — | — | — | — | — | — |
| | diisopropylphenyl)carbodiimide | | | | | | | |

| | | | | | | | |
|---|---|---|---|---|---|---|---|
| Adhesive | 50° C. × 7 days | ∘ | ∘ | ∘ | ∘ | ∘ | ∘ |
| residue | 60° C. × 90% RH × 7 days | ∘ | ∘ | ∘ | ∘ | ∘ | ∘ |
| | 85° C. × 7 days | ∘ | ∘ | ∘ | ∘ | ∘ | ∘ |
| | 100° C. × 1 hour | ∘ | ∘ | ∘ | ∘ | ∘ | ∘ |
| | 130° C. × 1 hour | ∘ | ∘ | ∘ | ∘ | ∘ | ∘ |
| | 150° C. × 1 hour | ∘ | ∘ | ∘ | ∘ | ∘ | ∘ |

| | | | | | | | |
|---|---|---|---|---|---|---|---|
| Number-average molecular weight reduction | 130° C. × | 0.0 | 0.0 | 0.0 | 0.0 | 3.4 | 0.0 |
| ratio of polyol (%) | 1 hour | | | | | | |

TABLE 2

| | | | | Presence or | | | | |
|---|---|---|---|---|---|---|---|---|
| | | | | absence of | | | | |
| | | | Number of | hindered | | | | |
| | | | functional | phenol | | | | Example |
| | | Mn | groups | structure | Example 7 | Example 8 | Example 9 | 10 |
| Polyol (A) | S3011 | 10,000 | 3 | — | 100 | 100 | 100 | 100 |
| Polyfunctional | CORONATE HX | 504 | 3 | — | 12 | 12 | 12 | 12 |
| isocyanate | | | | | | | | |
| compound (B) | | | | | | | | |

| Equivalent | | — | 2 | 2 | 2 | 2 |
|---|---|---|---|---|---|---|
| Catalyst | Nacem Ferric Iron | — | — | — | — | — |
| | EMBILIZER OL-1 | — | 0.08 | 0.08 | 0.08 | 0.08 |
| Deterioration- | Irganox 1135 | Present | 0.5 | — | — | — |
| preventing | Irganox 1520L | Present | — | 0.5 | — | — |
| agent | Irganox E201 | Present | — | — | 0.5 | — |
| | Irganox 1726 | Present | — | — | — | 0.5 |

| | | | | | |
|---|---|---|---|---|---|
| Adhesive | 50° C. × 7 days | ∘ | ∘ | ∘ | ∘ |
| residue | 60° C. × 90% RH × 7 days | ∘ | ∘ | ∘ | ∘ |
| | 85° C. × 7 days | ∘ | ∘ | ∘ | ∘ |
| | 100° C. × 1 hour | ∘ | ∘ | ∘ | ∘ |
| | 130° C. × 1 hour | ∘ | ∘ | ∘ | ∘ |
| | 150° C. × 1 hour | ∘ | ∘ | ∘ | ∘ |

| | | | | | |
|---|---|---|---|---|---|
| Number-average molecular weight | 130° C. × | 0.0 | 0.0 | 0.0 | 0.0 |
| reduction ratio of polyol (%) | 1 hour | | | | |

TABLE 3

| | | | | | |
|---|---|---|---|---|---|
| | | Presence or | | | |
| | | absence of | | | |
| | Number of | hindered | | | |
| | functional | phenol | | | |
| Mn | groups | structure | Example 11 | Example 12 | Example 13 |

| | | | | | | | |
|---|---|---|---|---|---|---|---|
| Polyol (A) | S3011 | 10,000 | 3 | — | 100 | 100 | 100 |
| Polyfunctional | CORONATE HX | 504 | 3 | — | 12 | 12 | 12 |
| isocyanate compound (B) | | | | | | | |

| Equivalent | | — | 2 | 2 | 2 |
|---|---|---|---|---|---|
| Catalyst | Nacem Ferric Iron | — | — | 0.04 | 0.04 |
| | EMBILIZER OL-1 | — | 0.08 | — | — |
| Deterioration-preventing | Irganox 1010 | Present | — | — | — |
| agent | Dibutylhydroxytoluene | Present | — | — | — |
| | TINUVIN 326 | Present | — | — | — |
| | TINUVIN 765 | Absent | 0.5 | — | — |
| | 1,4-Diazabicyclo[2.2.2]octane | Absent | — | 0.5 | — |
| | Bis(2,6-diisopropylphenyl)carbodiimide | Absent | — | — | 0.5 |

| | | | | |
|---|---|---|---|---|
| Adhesive residue | 50° C. × 7 days | ∘ | ∘ | ∘ |
| | 60° C. × 90% RH × 7 days | ∘ | ∘ | ∘ |
| | 85° C. × 7 days | ∘ | ∘ | ∘ |
| | 100° C. × 1 hour | ∘ | ∘ | ∘ |
| | 130° C. × 1 hour | ∘ | ∘ | ∘ |
| | 150° C. × 1 hour | ∘ | ∘ | ∘ |

| | | | | |
|---|---|---|---|---|
| Number-average molecular weight | 130° C. × 1 hour | 5.19 | 0.0 | 2.5 |
| reduction ratio of polyol (%) | | | | |

TABLE 4

| | | | | Presence or | | | | | |
|---|---|---|---|---|---|---|---|---|---|
| | | | | absence of | | | | | |
| | | | Number of | hindered | | | | | |
| | | | functional | phenol | Comparative | Comparative | Reference | Reference | Reference |
| | | Mn | groups | structure | Example 1 | Example 2 | Example 1 | Example 2 | Example 3 |
| Polyol (A) | S3011 | 10,000 | 3 | — | 100 | 100 | 100 | 100 | 100 |
| Polyfunctional | CORONATE | 504 | 3 | — | 12 | 12 | 12 | 12 | 12 |
| isocyanate | HX | | | | | | | | |
| compound (B) | | | | | | | | | |

| Equivalent | | — | 2 | 2 | 2 | 2 | 2 |
|---|---|---|---|---|---|---|---|
| Catalyst | Nacem Ferric Iron | — | 0.04 | — | 0.04 | — | — |
| | EMBILIZER OL-1 | — | — | 0.08 | — | 0.08 | 0.08 |
| Deterioration- | Irganox 1010 | Present | — | — | — | — | — |
| preventing | Dibutylhydroxytoluene | Present | — | — | — | — | — |
| agent | TINUVIN 326 | Present | — | — | — | — | — |
| | TINUVIN 765 | Absent | — | — | 0.5 | — | — |
| | 1,4-Diazabicyclo[2.2.2]octane | Absent | — | — | — | 0.5 | — |
| | Bis(2,6- | Absent | — | — | — | — | 0.5 |
| | diisopropylphenyl)carbodiimide | | | | | | |

| | | | | | | |
|---|---|---|---|---|---|---|
| Adhesive | 50° C. × 7 days | ∘ | ∘ | ∘ | ∘ | ∘ |
| residue | 60° C. × 90% RH × 7 days | Δ | Δ | Δ | Δ | Δ |
| | 85° C. × 7 days | Δ | Δ | Δ | Δ | Δ |
| | 100° C. × 1 hour | Δ | Δ | Δ | Δ | Δ |
| | 130° C. × 1 hour | Δ | Δ | Δ | Δ | Δ |
| | 150° C. × 1 hour | Δ | Δ | Δ | Δ | Δ |

| | | | | | | |
|---|---|---|---|---|---|---|
| Number-average molecular weight reduction ratio of | 130° C. × 1 hour | 10.7 | 26.6 | 30.6 | 26.0 | 24.9 |
| polyol (%) | | | | | | |

### Example 14

The surface protective film (1) obtained in Example 1 was attached to a polarizing plate (manufactured by NITTO DENKO CORPORATION, trade name: “TEG1465DUHC”) as an optical member, to thereby provide an optical member having attached thereto a surface protective film.

### Example 15

The surface protective film (2) obtained in Example 2 was attached to a polarizing plate (manufactured by NITTO DENKO CORPORATION, trade name: “TEG1465DUHC”) as an optical member, to thereby provide an optical member having attached thereto a surface protective film.

### Example 16

The surface protective film (3) obtained in Example 3 was attached to a polarizing plate (manufactured by NITTO DENKO CORPORATION, trade name: “TEG1465DUHC”) as an optical member, to thereby provide an optical member having attached thereto a surface protective film.

### Example 17

The surface protective film (5) obtained in Example 5 was attached to a polarizing plate (manufactured by NITTO DENKO CORPORATION, trade name: “TEG1465DUHC”) as an optical member, to thereby provide an optical member having attached thereto a surface protective film.

### Example 18

The surface protective film (7) obtained in Example 7 was attached to a polarizing plate (manufactured by NITTO DENKO CORPORATION, trade name: “TEG1465DUHC”) as an optical member, to thereby provide an optical member having attached thereto a surface protective film.

### Example 19

The surface protective film (8) obtained in Example 8 was attached to a polarizing plate (manufactured by NITTO DENKO CORPORATION, trade name: “TEG1465DUHC”) as an optical member, to thereby provide an optical member having attached thereto a surface protective film.

### Example 20

The surface protective film (9) obtained in Example 9 was attached to a polarizing plate (manufactured by NITTO DENKO CORPORATION, trade name: “TEG1465DUHC”) as an optical member, to thereby provide an optical member having attached thereto a surface protective film.

### Example 21

The surface protective film (10) obtained in Example 10 was attached to a polarizing plate (manufactured by NITTO DENKO CORPORATION, trade name: “TEG1465DUHC”) as an optical member, to thereby provide an optical member having attached thereto a surface protective film.

### Example 22

The surface protective film (11) obtained in Example 11 was attached to a polarizing plate (manufactured by NITTO DENKO CORPORATION, trade name: “TEG1465DUHC”) as an optical member, to thereby provide an optical member having attached thereto a surface protective film.

### Example 23

The surface protective film (12) obtained in Example 12 was attached to a polarizing plate (manufactured by NITTO DENKO CORPORATION, trade name: “TEG1465DUHC”) as an optical member, to thereby provide an optical member having attached thereto a surface protective film.

### Example 24

The surface protective film (13) obtained in Example 13 was attached to a polarizing plate (manufactured by NITTO DENKO CORPORATION, trade name: “TEG1465DUHC”) as an optical member, to thereby provide an optical member having attached thereto a surface protective film.

### Example 25

The surface protective film (1) obtained in Example 1 was attached to a conductive film (manufactured by NITTO DENKO CORPORATION, trade name: “ELECRYSTA V270L-TFMP”) as an electronic member, to thereby provide an electronic member having attached thereto a surface protective film.

### Example 26

The surface protective film (2) obtained in Example 2 was attached to a conductive film (manufactured by NITTO DENKO CORPORATION, trade name: “ELECRYSTA V270L-TFMP”) as an electronic member, to thereby provide an electronic member having attached thereto a surface protective film.

### Example 27

The surface protective film (3) obtained in Example 3 was attached to a conductive film (manufactured by NITTO DENKO CORPORATION, trade name: “ELECRYSTA V270L-TFMP”) as an electronic member, to thereby provide an electronic member having attached thereto a surface protective film.

### Example 28

The surface protective film (5) obtained in Example 5 was attached to a conductive film (manufactured by NITTO DENKO CORPORATION, trade name: “ELECRYSTA V270L-TFMP”) as an electronic member, to thereby provide an electronic member having attached thereto a surface protective film.

### Example 29

The surface protective film (7) obtained in Example 7 was attached to a conductive film (manufactured by NITTO DENKO CORPORATION, trade name: “ELECRYSTA V270L-TFMP”) as an electronic member, to thereby provide an electronic member having attached thereto a surface protective film.

### Example 30

The surface protective film (8) obtained in Example 8 was attached to a conductive film (manufactured by NITTO DENKO CORPORATION, trade name: “ELECRYSTA V270L-TFMP”) as an electronic member, to thereby provide an electronic member having attached thereto a surface protective film.

### Example 31

The surface protective film (9) obtained in Example 9 was attached to a conductive film (manufactured by NITTO DENKO CORPORATION, trade name: “ELECRYSTA V270L-TFMP”) as an electronic member, to thereby provide an electronic member having attached thereto a surface protective film.

### Example 32

The surface protective film (10) obtained in Example 10 was attached to a conductive film (manufactured by NITTO DENKO CORPORATION, trade name: “ELECRYSTA V270L-TFMP”) as an electronic member, to thereby provide an electronic member having attached thereto a surface protective film.

### Example 32

The surface protective film (11) obtained in Example 11 was attached to a conductive film (manufactured by NITTO DENKO CORPORATION, trade name: “ELECRYSTA V270L-TFMP”) as an electronic member, to thereby provide an electronic member having attached thereto a surface protective film.

### Example 33

The surface protective film (12) obtained in Example 12 was attached to a conductive film (manufactured by NITTO DENKO CORPORATION, trade name: “ELECRYSTA V270L-TFMP”) as an electronic member, to thereby provide an electronic member having attached thereto a surface protective film.

### Example 34

The surface protective film (13) obtained in Example 13 was attached to a conductive film (manufactured by NITTO DENKO CORPORATION, trade name: “ELECRYSTA V270L-TFMP”) as an electronic member, to thereby provide an electronic member having attached thereto a surface protective film.

The urethane-based pressure-sensitive adhesive of the present invention can be used in any appropriate application. The urethane-based pressure-sensitive adhesive of the present invention is preferably used as the pressure-sensitive adhesive layer of a surface protective film because the pressure-sensitive adhesive is extremely excellent in adhesive residue-preventing property. With such procedure, the surface protective film can be suitably used in the surface protection of an optical member or electronic member.

According to the present invention, it is possible to provide the urethane-based pressure-sensitive adhesive that is extremely excellent in adhesive residue-preventing property. In addition, according to the present invention, it is possible to provide the surface protective film using such urethane-based pressure-sensitive adhesive in its pressure-sensitive adhesive layer, the surface protective film being extremely excellent in adhesive residue-preventing property. In addition, according to the present invention, it is possible to provide the optical member or electronic member to which such surface protective film is attached.

What is claimed is:

1. A urethane-based pressure-sensitive adhesive, comprising a polyurethane-based resin, wherein:
the polyurethane-based resin comprises a polyurethane-based resin obtained by curing a composition containing a polyol (A) and a polyfunctional isocyanate compound (B); and
the polyurethane-based resin contains a deterioration-preventing agent.

2. A urethane-based pressure-sensitive adhesive according to claim 1, wherein a content of the deterioration-preventing agent with respect to the polyol (A) is 0.01 wt % to 20 wt %.

3. A urethane-based pressure-sensitive adhesive according to claim 1, wherein the polyol (A) contains a polyol having a number-average molecular weight Mn of 400 to 20,000.

4. A urethane-based pressure-sensitive adhesive according to claim 1, wherein a content of the polyfunctional isocyanate compound (B) with respect to the polyol (A) is 5 wt % to 60 wt %.

5. A urethane-based pressure-sensitive adhesive according to claim 1, wherein the deterioration-preventing agent contains a deterioration-preventing agent having a hindered phenol structure.

6. A surface protective film, comprising:
a base material layer; and
a pressure-sensitive adhesive layer,
wherein the pressure-sensitive adhesive layer contains the urethane-based pressure-sensitive adhesive according to claim 1.

7. An optical member, comprising the surface protective film according to claim 6 attached thereto.

8. An electronic member, comprising the surface protective film according to claim 6 attached thereto.
